(19) United States
(12) Patent Application Publication
(10) Pub. No.: US 2006/0289657 A1
(43) Pub. Date: Dec. 28, 2006

(54) Methods and apparatus for user interaction with RFID cards

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: Outland Research, LLC, Pismo Beach, CA (US)

(21) Appl. No.: 11/341,100

(22) Filed: Jan. 27, 2006

Related U.S. Application Data
(60) Provisional application No. 60/693,642, filed on Jun. 25, 2005.

(51) Int. Cl. G06K 19/06

(52) U.S. Cl. 235/492

(57) ABSTRACT

A non-contact storage device includes a housing, an antenna coupled to the housing, electronic circuitry coupled to the antenna, control electronics adapted to generate a control signal when at least one predetermined event has occurred between the electronic circuitry and the card reader, and a tactile sensation generator coupled to the housing and connected to the electronic circuitry. The housing is adapted to be contacted by a user. The electronic circuitry includes a data memory and a transceiver for transferring data between the memory and a card reader via the antenna. The tactile sensation generator is configured to generate a tactile sensation corresponding to the control signal. Accordingly, the tactile sensation is adapted to be felt by a user via the housing to thereby inform the user of the occurrence of the at least one predetermined event.

This application claims the benefit of U.S. Provisional Application No. 60/693,642, filed Jun. 25, 2005, which is incorporated in its entirety herein by reference.

### BACKGROUND

1. Field of Invention

Embodiments disclosed herein relate generally methods and apparatus facilitating user interaction with non-contact data storage devices, and more specifically to methods and apparatus for providing users with enhanced interaction with and feedback from RFID cards.

2. Discussion of the Related Art

Presently, non-contact cards are being developed as a means of enabling a user to interface to a remote electronic device and exchange data with the remote electronic device by simply bringing a card within a certain proximity of an external radio transceiver. Such non-contact cards typically constitute a radio operated data card (i.e., an RFID card) including an RFID integrated circuit which incorporates data storage means, a radio frequency transceiver, and an on-card antenna. For example, RFID credit card systems are being deployed in select test locations across the United States. The Blink credit card system from Chase, for example, is a credit card scanning system that allows a user to hold his or her credit card within certain proximity of a reader in order to interface with the reader and exchange information, thereby paying for a purchase. The RFID credit card includes an RFID chip and the credit card reader includes an RFID reader system. In this way, the user of the RFID credit card need only position the card near a payment location to complete a purchase.

With current technology, feedback is given to the user from the card reader hardware, but not from the card itself. Such feedback from the reader hardware is provided as an audible beep and/or a flashing LED emitted from the reader hardware. There are significant problems and limitations of such feedback methods. First, the audible beep is not always discernable by a user because the environment of the card reader may be too noisy and the audible beep may not be heard. At other times, the environment includes many readers being used by many customers and so there may be numerous similar beeps happening at a given time from one or more of the many card readers that may not be easily distinguishable from each other. In this way, a particular user may not know if the beep was for related to his actions or if it was related to the actions of another customer at a nearby card reader. The visible light feedback method also has problems. For example, light emitted by an LED is not easily visible in bright outdoor environments. In addition, the visible light requires the user to focus his or her visible attention on the card reader hardware, taking his or her attention away from other things he or she may be doing, thereby reducing some of the inherent convenience associated with use of RFID card systems. Further, feedback such as visible light and audible beeps are problematic in that they are not private to a particular user. Indeed, they can be seen and/or heard by other people in the environment. For example, a visible light flash and/or audible beep that signals a credit-card denial can be embarrassing for the customer to whom it is intended.

Furthermore, because RF-enabled devices such payment cards can be read at a distance with a suitable transmitter and receiver, it is possible to surreptitiously obtain information from the card while it remains in its cardholder's possession, even while it remains in the cardholder's wallet or purse. To address this problem, RFID credit card devices have been proposed in US Patent Application Publication Nos. 2003/0132301 and 2004/0124248, both of which are hereby incorporated by reference. US Patent Application Publication Nos. 2003/0132301 and 2004/0124248 can be understood to disclose RFID cards including a manually operated switch to allow the user to control if and when the card is accessed by a card reader. The switch is a normally open electrical switch that is connected between the on-card electronic circuitry and the antenna. The open switch contacts normally disable the card, preventing the data on the card from being read until the switch contacts are intentionally closed by the cardholder to enable data transfer to occur. The cardholder may activate the card by manually pressing the surface of the card at a predetermined position, closing the switch contacts which open again automatically when pressure is removed.

Although such a switch gives the user control over the accessibility of a card by one or more non-contact readers, the current state of the art has no way to provide feedback to the user as to whether or not his or her card was successfully accessed by the non-contact reader. For example, the user may press the switch, enabling his or her card to be accessed by a reader, but the card may not be within sufficient proximity of the reader at the time the press was performed and hence the desired data exchange may not occur. Similarly, the current state of the art has no way for a card to give a user feedback as to whether a desired non-contact data exchange was successfully completed between the card and the reader.

### SUMMARY

Several embodiments disclosed herein address the needs above as well as other needs by providing a non-contact data storage device adapted to provide users with tactile sensations that facilitate user interaction with remote units adapted to access the non-contact data storage device.

One exemplary embodiment disclosed herein provides a radio operated data card that includes a housing, an antenna coupled to the housing, electronic circuitry coupled to the antenna, control electronics adapted to generate a control signal when at least one predetermined event has occurred between the electronic circuitry and the card reader, and a tactile sensation generator coupled to the housing and connected to the electronic circuitry. The housing is adapted to be contacted by a user and includes first and second panels that form an outer surface of the housing. Moreover, the antenna, the electronic circuitry, and the control electronics are sandwiched between the first and second panels. The electronic circuitry includes a data memory and a transceiver for transferring data between the memory and a card reader via the antenna. The tactile sensation generator is configured to generate a tactile sensation corresponding to the control signal. Accordingly, the tactile sensation is adapted to be felt by a user via the housing to thereby inform the user of the occurrence of the at least one predetermined event.

Another exemplary embodiment disclosed herein provides non-contact storage device that includes a housing, an antenna coupled to the housing, electronic circuitry coupled to the antenna, control electronics adapted to generate a control signal corresponding to the status of a transfer of data between the data memory and the remote unit, and a tactile sensation generator coupled to the housing and connected to the electronic circuitry. The housing adapted to be contacted by a user. The electronic circuitry includes a data memory and a transceiver for transferring data between the memory and a remote unit via the antenna. The tactile sensation generator is configured to generate a tactile sensation corresponding to the control signal. Accordingly, the tactile sensation is adapted to be felt by a user via the housing to thereby inform the user as to the status of the transfer of data.

In another exemplary embodiment, the control electronics is adapted to generate a control signal corresponding to an authentication status of the card with respect to the remote unit and the tactile sensation generator is configured to generate a tactile sensation informing the user as to the authentication status of the card with respect to the remote unit.

In still another exemplary embodiment, the control electronics is adapted to generate a control signal corresponding to the status of a payment transaction between the card and the remote unit and the tactile sensation generator is configured to generate a tactile sensation informing the user as to the status of the payment transaction.

In yet another exemplary embodiment, the control electronics is adapted to generate a control signal when the electronic circuitry has been activated in the presence of a radio signal transmitted by the remote unit and the tactile sensation generator is configured to generate a tactile sensation informing the user that the electronic circuitry has been activated by the remote unit.

In another embodiment, the non-contact storage device further includes an input manipulandum coupled to the electronic circuitry. In this embodiment, the input manipulandum is adapted to be engaged by the user to connect the antenna to the electronic circuitry. Accordingly, the control electronics adapted to generate a control signal when the electronic circuitry has not been activated within a predetermined amount of time after the user engages the input manipulandum and the tactile sensation generator is configured to generate a tactile sensation informing the user that the electronic circuitry has not been activated.

### BRIEF DESCRIPTION OF THE DRAWINGS

The above and other aspects, features and advantages of several embodiments of the embodiments exemplarily described herein will be more apparent from the following more particular description thereof, presented in conjunction with the following drawings.

FIG. 1 illustrates a top plan view of a first exemplary RF-enabled payment card employing a pressure-actuated manual switch for protecting the card against unauthorized use;

FIGS. 2 and 3 illustrate partial cross-sectional views of normal and actuated states, respectively, of the payment card shown in FIG. 1;

FIG. 4 illustrates a top plan view of a second exemplary RF-enabled payment card employing a employing a pressure-actuated manual switch for protecting the card against unauthorized use;

FIGS. 5 and 6 illustrate partial cross-sectional views of normal and actuated states, respectively, of the payment card shown in FIG. 4; and

FIG. 7A and FIG. 7B illustrate an embodiment of the present invention in which an RF-enabled payment card is un-flexed and flexed, respectively.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the embodiments disclosed below should be determined with reference to the claims.

Numerous embodiments of the present invention are adapted to provide electronically-controllable tactile feedback to a user via a non-contact information storage device (e.g., an RF-enabled card), wherein the electronically controlled tactile feedback is imparted by a tactile sensation generator under electronic control to the user of the card based upon the occurrence of predetermined events (successful and/or unsuccessful) relevant to the RFID card.

RF-enabled cards, identification tags, payment cards, and the like (herein referred to as “cards” or “data cards”) carry data which typically identifies and relates to a specific person, a particular account, an individual vehicle, or an item, and further contains additional data supporting applications through item specific information or instructions immediately available on reading the card. An RFID system requires, in addition to the data cards, a means of reading or interrogating the data cards and communicating the data between the card and a host computer or information management system (referred to herein as a “reader”). Communication of data between a card and a reader is achieved by wireless communication, either based upon close proximity electromagnetic or inductive coupling, or based upon propagating electromagnetic waves. Coupling is achieved using antenna structures forming an integral feature in both data cards and readers. As used herein, the term “antenna” refers to both propagating systems as well as inductive systems.

Data storage and processing as well as RF communications functions are typically performed on the data card by one or more integrated circuit chips. For example, the SRIX4K Smartcard Chip available from STMicroelectronics is a integrates a power reception system which uses the received RF signal as a power source, an emitter/receiver module compatible with the ISO 14443 standard, together with an asynchronous 8-bit micro-controller. The chip contains a 4096-bit user EEPROM fabricated with CMOS technology and stores data in 128 blocks of 32 bits each. The SRIX4K is accessed via the 13.56 MHz carrier. Incoming data are demodulated and decoded from the received amplitude shift keying (ASK) modulation signal and outgoing data are generated by load variation using bit phase shift keying (BPSK) coding of a 847 kHz sub-carrier. The SRIX4K chip is further described in the paper “A New Contactless Smartcard IC using an On-Chip Antenna and an Asynchronous Micro-controller” by Abrial A., at al., 26th European Solid-State Circuits Conference, Stockholm, Sep. 19, 20, 2000.

Using the STMicroelectronics single chip coupler, CRX14, a reader may be readily designed to create a complete an RFID system. Although these and other such systems include electronic authentication mechanisms for enhanced security, other methods have been developed to enhance the security of the information on the data card by disabling the data card except when the holder intends to use it. Accordingly, RFID cards may be provided with an input manipulandum adapted to enable a remote unit (e.g., a remote transmitter/reader, also referred to herein as a “reader,” “card reader,” “remote reader,” “scanner,” and “remote scanner”) to activate the RFID card and/or exchange data with the RFID card.

According to numerous embodiments, the input manipulandum may be provided as a pressure-responsive switch configured to sense if a user imparts a particular pressure upon the card, an accelerometer configured to sense if the user imparts a particular acceleration upon the card, a tilt sensor configured to sense the orientation in which the card is manipulated by the user, a temperature sensor to detect the presence of a user's finger or hand upon the card, or the like or combinations thereof.

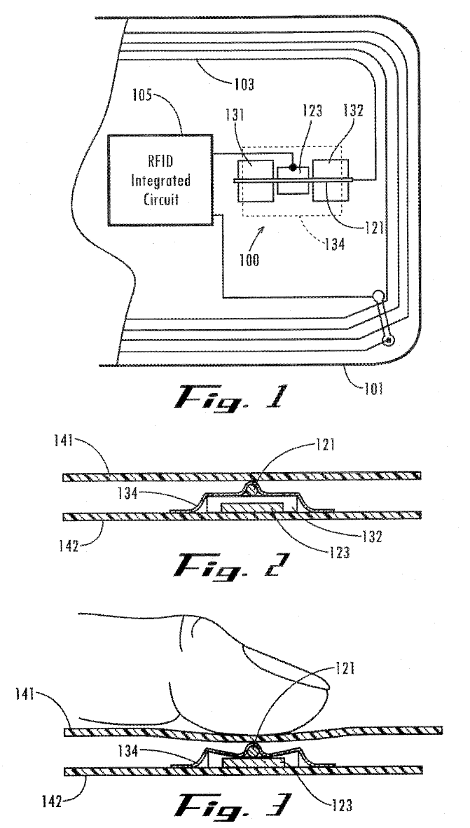

A first exemplary RFID card, including a first exemplary input manipulandum, will now be described with respect to FIGS. 1-3.

Referring to FIGS. 1-3, a pressure responsive switch 100 on an RFID payment card 101 acts as an input manipulandum and disconnects the antenna 103 from the on-card integrated circuit 105 when the card is not in use. The switch 100 is formed by a wire 121 connected to one end of the antenna 103 and held in a normally spaced-apart relationship from an electrical contact pad 123 by two support cushions 131 and 132. The support cushions 131 and 132 are formed of a resilient material and are positioned on each side of the contact pad 123. The wire 121 is secured by a thin adhesive strip 134 indicated by the dotted rectangle.

The switch 100 is sandwiched between two planar panels 141 and 142 which form the outer surfaces of the card 101 and which also house the integrated circuit 105 and the antenna 103. The panels 141 and 142 are attached at their periphery to form a sealed housing for the on-card electronics, switching mechanisms and antenna, and may be formed using any suitable non conducting material. The antenna 103 is formed with a helical conductive trace which follows the outer periphery of the card 101 and is available from RCD Technology Corporation, Bethlehem, Pa. The antenna could be made from any suitable conducting antenna design.

The switch 100 is actuated to complete a circuit between the antenna 103 and the chip 105 when the user pressed inwardly on the flexible outer surface of the card. The resilient cushions 131 and 132 deform, allowing the wire 121 to move into engagement with the contact pad 123 to establish and electrical connection.

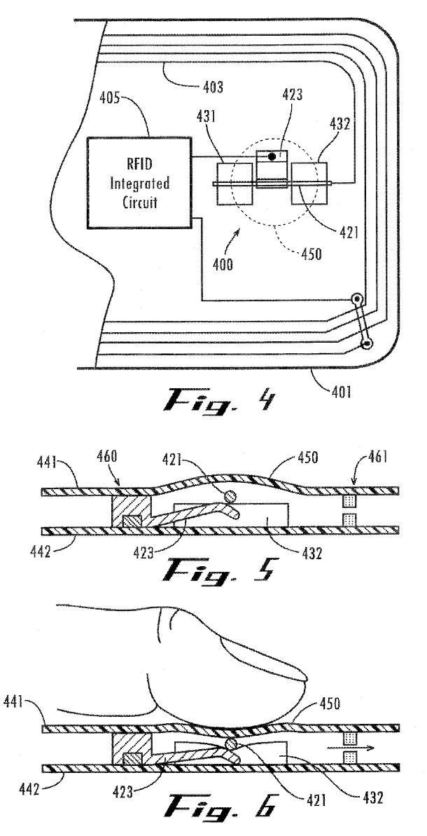

A second exemplary RFID card, including a second exemplary input manipulandum, will now be described with respect to FIGS. 4-6.

Referring to FIGS. 4-6, an exemplary RFID card 401 includes an antenna 403, an on-card RFID integrated circuit (IC) 405, an input manipulandum (i.e., switch 400), and a tactile sensation generator.

As shown in FIG. 4, the switch 400 is provided as a pressure-responsive switch mechanism and includes a wire 421, an electrical contact pad 423, and two support cushions 431 and 432. The wire 421 is connected to one end of the antenna 403 and held in a normally spaced-apart relationship from the electrical contact pad 423 by the two support cushions 431 and 432. The electrical contact pad 423 is connected to the RFID IC 405. The RFID IC 405 is connected to another end of the antenna 403. Accordingly, the switch 400 disconnects the antenna 403 from the RFID IC 405 until the switch is manipulated by the user.

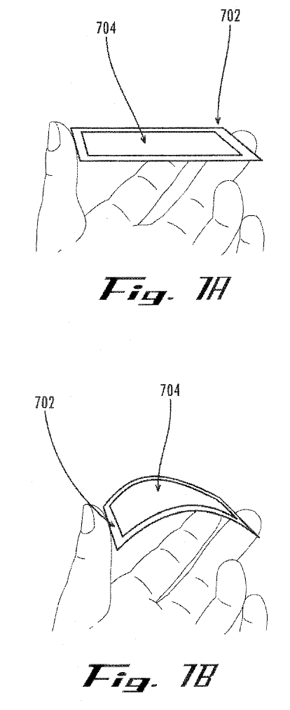

Referring to FIGS. 5 and 6, the RFID card 401 shown in FIG. 4, further includes upper and lower panels 441 and 442, respectively, which form the outer surfaces of the RFID card 401. The switch 400, the cushions 431 and 432, the RFID IC 405, the antenna 403, the control electronics, the power electronics, and any power generator and power storage components are all aboard the RFID card 401 between the upper and lower panels 441 and 442.

The upper panel 441 may be molded to form a dome-shaped dimple 450 that is sealed to the upper panel 441 at 460 and 461. In one embodiment, the dimple 450 may be positioned over the switch 400 and project to a height above an outer surface of the upper panel 411 sufficient to enable a user to feel the presence of the dimple on the card, thereby providing an indication to the user as to the place on the card which should be pressed to activate the card.

With general reference to FIGS. 1-6, when the antenna of either the first or second exemplary RFID cards is connected to a respective RFID IC incorporated therein via a respective switch, the antenna communicatively couples its respective RFID IC to a remote unit (e.g., a transmitter/reader), also referred to herein as a “reader” or “remote reader” or “remote unit” or “scanner” or “remote scanner” (not shown). Accordingly, the switch 100 or 400 of either the first or second exemplary RFID cards 101 or 401, respectively, prevents information on the card from being activated (or otherwise accessed) until it is manipulated by the user to enable signal transmission between the card and the remote unit.

As will be discussed in greater detail below, the tactile sensation generator may be separate from, or be included within the input manipulandum. In one embodiment discussed in greater detail below, the tactile sensation generator may be provided as a feedback actuator acting as the pressure sensor of a pressure-responsive switch. As will be discussed in greater detail below, the RFID card may be provided with a power generator adapted to provide electricity sufficient to power electronics within the RFID card, enabling data to be exchanged between the RFID card and, for example, a remote unit and/or enabling tactile feedback to be imparted to the user. In one embodiment, the power generator may be provided as a kinetic motion generator, a solar cell generator, a thermo-electric generator, or the like or combinations thereof. In another embodiment discussed in greater detail below, the tactile sensation generator also acts as a power generator. As will be discussed in greater detail below, the RFID card may be provided with a means of storing electricity (e.g., via battery storage, capacitive storage, or the like or combinations thereof).

In one embodiment, the tactile feedback may be imparted upon a user (i.e., a cardholder) through the RFID card as a localized tactile stimulus, directed for example at a user's finger tip that engages a specific area of the card. In another embodiment, tactile feedback is imparted upon the user through the card as a generalized tactile stimulus that is transferred throughout the card as an inertial sensation, the inertial sensation adapted to be felt by the user at predetermined areas of contact between the user and the card. In such an embodiment, the inertial sensation may be imparted upon the card through the relative motion of an inertial mass that is movably connected to the card. In one embodiment, the inertial mass is driven by a piezo-ceramic actuator. In another embodiment, the inertial mass is driven by an electro-active polymer actuator. In yet another embodiment, the inertial mass may be driven by an electromagnetic (e.g., a voice coil) actuator. In still another embodiment, the card itself may be composed partially or entirely of an electro-active polymer material such that the card itself will deform under electronic control when energized by control electronics. For example, the dimensions of the card may expand slightly when energized, thus creating a tactile sensation in the hand of a user who is holding the card between his or her fingers. In yet another embodiment, the tactile feedback is imparted upon the card through electrical current that is imparted to a portion of a user's finger, fingers, or hand. For example, a mild electric shock may be imparted upon the finger of a user (e.g., via an electrical stimulus actuator) to impart a discernable tactile sensation that is informative and not uncomfortable.

In one embodiment, electronically controlled tactile feedback can be provided to a user via an RFID card when the RFID card is activated (or otherwise accessed) and read by a reader. In such an embodiment, the RFID card can be activated (or otherwise accessed) and read by the reader whenever the RFID card is brought within a certain proximity of the reader. In another embodiment, the RFID card can be activated (or otherwise accessed) and read by the reader whenever the RFID card is brought within a predetermined proximity of the reader and when the RFID card is specifically enabled to be activated (or otherwise accessed) by a user who properly engages an input manipulandum (e.g., one or more manual switches or other user-manipulatable elements).

The tactile sensation generator may include one or more low-profile low-power actuators formed from EAP material, piezoelectric material, or the like, or combinations thereof, electromagnetic actuators, electrical stimulation devices, and the like, or combinations thereof.

In one embodiment, the low-profile low-power actuator includes an electro-active polymer (EAP) material. EAP materials are a class of polymers that can be formulated and/or processed to exhibit a wide range of physical, electrical, and electro-optical behaviors and properties. When activated (e.g., via an applied voltage), EAP materials undergo significant physical movement or deformation (i.e., electrostriction). These deformations can be along the length, width, thickness, radius, etc. of the material and in some cases can exceed 100% strain. Many EAP materials can also act as high quality sensors, particularly for time-varying (i.e., AC) signals. When mechanically deformed (e.g. by bending, pulling, etc.), most EAP materials develop differential voltages which can be electrically measured. Accordingly, EAP materials can be fashioned into sensors adapted to detect user manipulation of an input manipulandum provided with the RFID card. Moreover, EAP materials can be fashioned into generators for generating power based upon user manipulation of the input manipulandum. Many EAP materials exhibit bi-directional behavior, and can act as either sensors or actuators, or act simultaneously as both sensors and actuators, depending on system design.

Numerous aspects of the design and implementation of actuators, sensors, and generators formed from EAP materials are disclosed in U.S. Pat. No. 6,882,086 and U.S. Pat. No. 6,812,624 and U.S. Pat. No. 6,768,246, all of which are hereby incorporated by reference for all purposes as if fully set forth herein. Moreover, a variety of EAP structures are described in the papers, “High-field electrostriction of elastomeric polymer dielectrics for actuator,” by Kombluh et al., “Electro-mechanics of ionoelastic beams as electrically-controllable artificial muscles,” by M. Shahinpoor, “Polymer Electrolyte Actuator with Gold Electrodes,” by K. Oguro et al., and “Microgripper design using electro-active polymers,” by R. Lumia et al., all SPIE Conf. on Electroactive Polymer Actuators and Devices, SPEE Vol. 3669, 1999, all incorporated herein by reference. Depending upon its application, the EAP material employed for the low-profile low-power actuator may include gels, ionic polymers (e.g., ionic polymer metal composites or IPMC), conducting polymers, and electrorestrictive polymers.

In a majority of EAP materials, the actuation mechanism is based on the movement of ionic species either in or out of a polymer network. Currently, the most commercially viable of these is the electrostrictive polymer class. Electrorestrictive polymers presently can be classified in two classes: dielectric and phase transition. Dielectric polymers typically include a dielectric polymer sandwiched between two electrically conductive (and compliant) electrodes. At high electric fields (e.g., at 100's to 1000's of volts), the attractive force of the electrodes squeezes the dielectric polymer to induce significant motion (strain) therein. In some cases, this strain can be greater than 100%.

Electrostrictive EAP materials can be deformed uniformly or non-uniformly, across the entire material or at select portions of the material depending upon how electricity is applied. Generally, the use of such material properties has been to develop actuators (motors) for powering movable robots and mechanical equipment. U.S. Pat. No. 6,376,971, hereby incorporated by reference along with all related provisional applications, can be understood to describe methods for converting electrical energy to mechanical energy through the use of electrostrictive EAP materials in addition to disclosing the use of compliant electrodes.

EAP materials have been used to provide tactile feedback in prior art devices, including devices disclosed in US Patent Application Publication No. 2004/0164971, which is hereby incorporated by reference, and US Patent Application No. 2002/0054060, which is also hereby incorporated by reference.

Many types of EAP material are highly resilient. Accordingly, other embodiments use EAP material in place of, or in combination with other resilient materials used within switches and/or other user manipulatable elements of an RF-enabled card.

In another embodiment, the low-profile low-power actuator includes a piezoelectric material. U.S. Pat. No. 6,781,289, which is hereby incorporated by reference, can be understood to disclose a piezoelectric element constructed from a piezoelectric material having a suitable crystalline structure. When an external electrical voltage is applied, a mechanical reaction of the piezoelectric element ensues, which is a function of the crystalline structure and the regions of contact with the electrical voltage exerts a pressure or tension in a pre-determinable direction. German Patent Disclosure DE 196 50 900, can be understood to disclose a piezoelectric actuator suitable for actuating control valves or injection valves in motor vehicles. To that end, the piezoelectric actuator comprises layers, stacked on one another in the manner of a laminate, of piezoelectric material with metal or electrically conductive layers serving as electrodes located between them. When subjected to a varying electrical voltage on their electrode layers, such piezoelectric multilayer actuators execute similarly varying forces. As will be described in greater detail below, such varying forces can be applied directly to the finger or hand of a user thereby imparting a tactile sensation when a piezoelectric actuator is incorporated within or affixed to an RF-enabled card. As will also be described in greater detail below, such varying forces can be applied to an inertial mass, the motion of the inertial mass imparting a tactile sensation upon a user when the piezoelectric actuator is incorporated within and/or affixed to an RF-enabled card. Piezoelectric materials have been used to provide tactile feedback in prior art devices, including devices disclosed in U.S. Pat. Nos. 6,429,846 and 6,822,635 and 6,563,487, all three of which are hereby incorporated by reference.

U.S. Pat. No. 4,430,595, which is hereby incorporated by reference, can be understood to disclose a sensor element constructed form a piezoelectric material. Such a piezoelectric sensor generates an electrical signal responsive to pressure applied thereto. Furthermore, the piezoelectric sensor can be configured to function as a switch and/or other input means that detects the manipulation by a user. Specifically, U.S. Pat. No. 4,430,595 can be understood to disclose a user adjustable switch, the switch including a piezoelectric plate sandwiched between two electrodes and polarized in the direction of the thickness thereof and supported on an elastic member that, in turn, is mounted on a housing. The switch further includes an electrically conductive plate secured to an electrode formed on an upper surface of the piezoelectric plate and a striking means interposed between a depressing member and the electrically conductive plate.

With reference back to the first and second exemplary RFID cards shown in FIGS. 1-6, each set of the two support cushions (i.e., support cushions 131/132 and 431/432) may be formed of a resilient electro-active polymer material having flexible electrodes disposed thereupon or therein. Accordingly, the sets of support cushions 131/132 and 431/432 constitute tactile sensation generators (herein provided as EAP material actuators) that are integrated within a respective input manipulandum (i.e., a respective switche 100 and 400). In one embodiment, any of the sets of support cushions 131/132 and 431/432 can be formed as a single piece of EAP material, thereby requiring only one set of electrodes to form an EAP material actuator.

In another embodiment, each support cushion within an RFID card can be formed as single piece of EAP material, each having their own set of electrodes. Where each support cushion is formed as a separate piece of EAP material, electrodes within a set of support cushions may be electronically connected to each other to facilitate coordinated control of the EAP material actuators within an RFID card.

The electrodes within a set of support cushions as described above may be connected by wires to power electronics within the RFID card and the power electronics can be adapted to regulate power sent to the electrodes and thereby regulate the reliance and/or thickness of the support cushions. The power electronics may be connected to control electronics and the control electronics can be adapted to selectively control the power electronics to selectively control the EAP material actuator. In one embodiment, the power electronics may be integrated within the control electronics (e.g., as part of the same IC). Moreover, the control electronics may be incorporated within the RFID IC aboard the RFID card (e.g., RFID IC 105 or 405). For purposes of discussion, the electrical signal sent from the control electronics to the power electronics is referred to herein as a “control signal” and the electrical signal sent from the power electronics to the electrodes of the EAP material actuator (or to other actuators that may be used in its place) is referred to herein as an “activation signal”.

In one embodiment, signal conditioning electronics may be provided (e.g., within the RFID IC 105 or 405 or as part of the same integrated circuit as the control electronics) to condition the control signal generated by the control electronics. In another embodiment, the signal conditioning electronics includes a digital-to-analog converter (D/A) adapted to convert a digital signal generated by the control electronics into an analog signal useful for driving the tactile sensation generator.

In embodiments that employ sensors and/or use components dually as sensors and actuators, such sensors may be connected to the control electronics via well known means to enable the control electronics to detect signals from the sensors and respond accordingly. Additionally, in embodiments that employ sensors and/or use components dually as sensors and actuators, the control electronics may be adapted to process values derived from the signals generated by the sensors and respond accordingly. Further, the signal conditioning electronics may be employed to condition sensor signals. For example, the signal conditioning electronics includes an analog-to-digital converter (A/D) adapted to convert analog sensor signals into digital values suitable for being processed by the control electronics.

Having generally described RFID cards above (e.g., as with the first and second exemplary RFID cards 101 and 401), an exemplary method of their operation will now be generally described (a more detailed description of the operation of the input manipulandum may be found in U.S. Patent Application Publication No. 2003/0132301, which is hereby incorporated by reference).

Generally, the input manipulandum includes a pad or surface adapted to be engaged by the finger of a user. In the embodiments exemplarily described with respect to FIGS. 1-6, an input manipulandum may include switching mechanism that may take the form of normally spaced-apart electrical contacts positioned adjacent to one another within the card but held in a non-contacting relationship by a support cushion formed of a resilient material, wherein the resilient material includes EAP material or piezoelectric material, or the like, or combinations thereof. When the cardholder presses on the surface of the card in the predetermined location of the pad or surface, the pad or surface deflects, moving one of the two contacts into engagement with the other while deforming the resilient material. When the applied pressure is removed, the resilient material including the electro-active polymer material moves the contacts apart again, breaking the electrical connection, and disabling the card's ability to receive and transmit information via antenna. In one embodiment, the deformation of the electro-active polymer material generates electricity that is used by control electronics, power electronics, other circuitry within an RFID IC, and/or otherwise stored aboard the RFID card. In this way, user activation of the pad is used both as a user input interface and as a power generation mechanism. In one embodiment, the pad is also used as a tactile feedback actuation means. Thus, the pad or surface included within the input manipulandum provides a target for the user's finger to receive tactile stimulation. In one embodiment, the resilient material forming the support cushion is selectively energized by control electronics within the card, functioning alone or in combination with remote electronics, the electro-active polymer when energized deforming under electronic control. The electronically controlled deformation of the resilient material that forms the support cushion may be felt by the user as a tactile stimulus. In one embodiment, a variety of activation signal profiles can be imparted upon the electro-active polymer thereby enabling a variety of tactilely distinctive sensations. In one embodiment, energized deformation caused by at least one of the activation profiles includes a cyclic deformation that imparts a vibration sensation felt by a user.

As described with respect to the first and second exemplary RFID cards 101 and 401, a tactile sensation generator is included within a respective input manipulandum (e.g., pressure-responsive switch mechanism 100 or 400), thereby ensuring that a tactile sensation will be provided to the user when the user engages the input manipulandum. In another embodiment, however, the tactile sensation generator may be disposed at any other location within or upon the RFID card that can be engaged by one or more fingers or hand of the user.

As will be discussed in greater detail below, the control electronics includes circuitry adapted to selectively control the power electronics. As used herein, the term “circuitry” refers to any type of executable instructions that can be implemented as, for example, hardware, firmware, and/or software, which are all within the scope of the various teachings described. Accordingly, the circuitry may be adapted to generate a control signal having one of a plurality of predetermined control signal profiles to the power electronics. In this way the circuitry can generate a control signal having one of a plurality of predetermined profiles and output the control signal to the power electronics. Responsive to the profile of the control signal, the power electronics may be adapted to produce an activation signal having an activation signal profile adapted to impart one of a plurality of tactile sensations upon the user via the RFID card 401.

In one embodiment, the control electronics is configured (e.g., by code within the circuitry) to selectively cause the generation of one or more tactile sensations in response to one or more successful events relevant to the card.

For example, the control electronics may be configured to produce a control signal having a particular control signal profile when the circuitry determines that the card has been successfully activated (or otherwise accessed) by a card reader. In this way, when the card is successfully activated (or otherwise accessed) by a card reader, the control electronics produces a control signal, the control signal is conveyed to the power electronics, and, in response to the control signal, the power electronics produces an activation signal. In one embodiment, the activation signal may simply be an amplified version of the control signal. The activation signal is then conveyed to the actuator (i.e., the aforementioned EAP material actuator) and the actuator produces a tactile sensation in response to the activation signal. In one embodiment, the form of the tactile sensation produced by the actuator corresponds to the form of the activation signal profile of the activation signal. For example, if the activation signal profile of the activation signal is a single pulse, the tactile sensation produced by the actuator is felt as a single pulse. If the activation signal profile of the activation signal is a sine wave vibration at a particular frequency, the tactile sensation is felt as a sine wave vibration at that particular frequency. Accordingly, the user can feel a particular electronically controlled tactile sensation when the card has been successfully activated (or otherwise accessed) by the card reader. In one embodiment, the sensation can be felt by the user through the finger that is pressing a switch (e.g., switch 100 or 400). Accordingly, the user can press the switch to activate an RFID card (e.g., first or second RFID card 101 or 401) and subsequently be given feedback through the switch to his or her finger indicating if and when a reader has successfully activated (or otherwise accessed) the card. As a result, a user can press the switch while approaching a card reader and, when the user feels the feedback, the user will know that he or she has come within a sufficient range and knows to stop approaching the reader. Conversely, if the user does not feel feedback, the user will know that the switch press was not effective and can continue to approach the reader or otherwise adjust his or her action accordingly.

In another example, the control electronics may be configured to produce a control signal having a particular control signal profile at times other than when the circuitry determines that the card has been successfully activated (or otherwise accessed) by a card reader. Thus, the control electronics may be configured to, for example, produce a tactile sensation upon the user while data is being transferred from the card to the card reader. Moreover, the control electronics may be configured to, for example, produce different tactile sensations upon the user based upon different detected events relevant to the card.

For purposes of illustration only, the control electronics may be configured to produce a “double jolt” sensation when the card is activated (or otherwise accessed) by a card reader, the “double jolt” sensation being a series of two force pulses imparted upon the user in rapid succession. Each force pulse may, for example, be about 100 milliseconds long and the two force pulses may be separated by about 300 milliseconds. Similarly, the control electronics may be configured to produce a “mild vibration” sensation when the card is in the process of transferring data to a reader. The “mild vibration” sensation may, for example, be a periodic force signal of a sine wave form and have a frequency of about 85 HZ. In this way, the “mild vibration” sensation, having a duration equal to the duration of the data transfer, allows the user to experience the data transfer process as buzzing information is moving past his or her finger, out of the card, and to the scanner. Accordingly, the “mild vibration” is an intuitive and informative sensation that represents data transfer. Similarly, the control electronics may be configured to produce a “double buzz” sensation when an interaction between the card and the card reader is complete. The “double buzz” sensation may, for example, include two short bursts of a vibration sensation, wherein each burst has a frequency of about 120 HZ and lasts about 250 milliseconds, and wherein each burst is separated by about 100 milliseconds of no force. In this way, one or more distinct tactile sensations may be imparted upon the user to uniquely inform the user about events relating to card access and/or card data transfer. As will be appreciated, the sensations described above, and their mapping to particular events relevant to a card, are provided for illustrative purposes only. Not all embodiments require the use of three different sensations, nor do they require the use of the particular sensations described above. Substantially any other sensation or sensations may be generated depending upon the profile of the control signal and resulting activation signal.

In one embodiment, the control electronics may artificially delay the time between when predetermined events relevant to the card occur and when a control signal is generated to produce one or more tactile sensations (e.g., to account for limitations of the human perceptual system with respect to the time scales of relevant card events). Accordingly, the control electronics may artificially delay the time between when, for example, successful card access, data transfer, and data transfer completion have occurred and when a control signal is generated to produce one or more tactile sensations. For example, the time of data transfer may be very quick and may be almost simultaneous with successful card access to the time scale of the human perceptual system. In such or similar cases, the control electronics may be configured to artificially delay the time between a sensation that indicates successful card access by the card reader and a sensation that indicates the completion of data transfer between the card and the card reader.

In one embodiment, the control electronics is configured (e.g., by code within the circuitry) to selectively cause the generation of one or more tactile sensations in response to one or more non-events or failed events relevant to the card.

For purposes of illustration only, the control electronics may be configured to produce a “time-out” sensation if a user engages the input manipulandum (e.g., by pressing a switch, etc.) and the card is not successfully activated (or otherwise accessed) by a reader within a certain time period. Similarly, the control electronics may be configured to produce an “access-failed” sensation if it detects that a card reader tried to access the card and failed. Similarly, the control electronics may be configured to produce a “transfer-failed” sensation if it determines that a data transfer was begun but failed to successfully complete. In this way, tactile sensations may be imparted upon the user to inform the user about non-events and/or failed events relating to card access and/or card data transfer. In one embodiment, one or more of the “time-out”, “access-failed”, and “transfer-failed” sensations may be distinct. In another embodiment, the “time-out”, “access-failed”, and “transfer-failed” sensations may all be the same or similar. Thus, the user need only recognize what it feels like for the card event to fail or time-out and is thereby sufficiently informed that a desired action did not transpire.

In embodiments where high security is desired, an explicit step of authentication may be required such that the card reader must authenticate the user based upon the data stored within the RFID card prior to granting the user access to some service or device and/or prior to accepting some data from the user's card. In such embodiments, the control electronics may be configured to provide one or more tactile feedback sensations corresponding to various events related to the authentication process.

For example, the control electronics may be configured to produce an “access granted” sensation when the card has been successfully authenticated by a card reader, thereby informing the user that his or her card has been read and successfully authenticated by the card reader for access to a desired service, device, and/or data exchange. Similarly, the control electronics may be configured to produce an “access denied” sensation when the card has been rejected by a card reader, thereby informing the user that his or her card has been read and has not been successfully authenticated by the card reader and has been denied access to a desired service, device, and/or data exchange. In one embodiment, the “access granted” and “access denied” sensations may be distinct (i.e., produced as a result of different and distinct control signal profiles and/or activation signal profiles) such that the sensations are differentiable by the user. In this way, the user can feel the difference between his or her card having been granted access or denied access to a desired service, device, and/or data exchange. In another embodiment, the control electronics determines or detects whether or not the card has been authenticated by the card reader and selectively generates either an “access granted”-related control signal profile or an “access denied”-related control signal profile based upon the determination of the detection. If the control electronics determines and/or detects that the card has been authenticated, the control electronics generates a control signal having a control signal profile configured to cause an actuator to produce an “access granted” sensation. If the control electronics determines and/or detects that the card has not been authenticated, the control electronics generates a control signal having a control signal profile configured to cause an actuator to produce an “access denied” sensation.

An exemplary process of generating tactile sensations will now be discussed in greater detail. The control electronics determines whether a sensation should be produced at a particular time. For example, the control electronics determines whether a successful event or an unsuccessful event relevant to the card has occurred. If the control electronics determines that a relevant successful or unsuccessful event has occurred, the control electronics generates a control signal having control signal profile corresponding to the relevant successful or unsuccessful event determined to have occurred. The control electronics may be configured to generate a control signal having one or more distinct control signal profiles. In embodiments where the control electronics is configured to generate a plurality of distinct control signal profiles, the control electronics may select a particular one of a plurality of predetermined control signal profiles based on a successful or unsuccessful event determined to have occurred.

As used herein, the term “profile” refers to a time varying instantiation of a signal. In one embodiment, the control signal profile may have a simple time varying configuration. For example, the simple time-varying configuration may be characterized as an on-off profile (e.g., turning on for an amount of time and then turning off). The on-off profile may have a constant on-time duration or may have a variable on-time duration. In another embodiment, the control signal profile may have a complicated time varying configuration. For example, the complicated time-varying configuration may be characterized as profile having a magnitude that varies over time. In another example, the complicated time-varying configuration may be characterized as a profile having a frequency that periodically varies over time (e.g., as a sine wave, a triangle wave, a saw tooth wave, etc.). In yet another example, the complicated time-varying configuration may be characterized as profile having a magnitude and frequency that varies over time.

The generated control signal, characterized by a control signal profile, is output as an electrical signal to the power electronics. The power electronics accepts the control signal and produces an activation signal. In one embodiment, the activation signal is an amplified version of the control signal. The activation signal produced by the power electronics is output as an electric signal to the actuator. The actuator may be an EAP material actuator as described above or may be any suitable actuator adapted to produce a tactile sensation that the user of the card can feel in response to the activation signal. Other suitable actuators may include a piezoelectric ceramic actuator, an electromagnetic actuator (e.g., a voice coil), or the like, or combinations thereof.

As described above, the control electronics aboard the RFID card (e.g., first or second exemplary RFID card 101 or 401) is configured to selectively generate a control signal that ultimately causes an actuator to produce a tactile sensation upon the user. In one embodiment, however, remote reader electronics embodied within the card reader may be used, either alone or in combination with the control electronics, to generate a control signal having one or more control signal profiles. For example, where the card reader has access to signals indicating whether or not the RFID card has been authenticated or rejected, the card reader outputs a radio signal that explicitly triggers an “access granted” or “access denied” sensation to be produced upon the user of the card based on whether or not the card has been authenticated or rejected, respectively. In this way, the reader selects and transmits a particular control signal profile to the RFID card (e.g., first or second exemplary RFID card 101 or 401) based upon events relevant between the card and the card reader. In another example, the reader generates and transmits a control signal profile to correspond with the profile of a desired sensation, the control electronics aboard the RFID card (e.g., first or second exemplary RFID card 101 or 401) receives the control signal profile from the card reader and converts it into an activation signal profile suitable for driving the actuator to produce the desired sensation. In this way, the card reader serves, at least in part, as the control electronics for selecting an imparting a tactile sensation by selecting a control signal profile and outputting the selected control signal profile to the power electronics, thereby causing the power electronic aboard the RFID card (e.g., first or second exemplary RFID card 101 or 401) to output an activation signal to the actuator.

Power may be supplied to the power electronics in order for the power electronics to drive the tactile sensation generator. In one embodiment, power may be generated by the antenna aboard the RFID card (e.g., antenna 103 or 403 as described above with respect to the first or second exemplary RFID cards 101 or 401, respectively) as a result of the influence of radio frequency signals transmitted by the card reader.

In another embodiment, a power storage component (not shown) may be included aboard the RFID card (e.g., first or second exemplary RFID card 101 or 401) to store power (e.g., power generated by the antenna when the antenna is in the presence of electromagnetic fields produced by one or more card readers) over time such that the power electronics can output activation signals to the tactile sensation generator when needed. Such a power storage component may, for example, include a capacitor, a battery, and the like, or combinations thereof. In yet another embodiment, the RFID card (e.g., first or second exemplary RFID card 101 or 401) may be configured to be plugged in, docked, or otherwise connected to a power supply (e.g., a wall outlet, USB hub, or other power supplying connection) for period of time, to charge the power storage component.

In still another embodiment, a power generator may be included aboard the RFID card (e.g., first or second exemplary RFID card 101 or 401) to eliminate and/or reduce the need for charging the power storage component within the card.

In one embodiment, the power generator may include a device formed of EAP material (i.e., an EAP power generator) that generates electric power when manipulated by the user. An EAP power generator may, for example, be incorporated within the switch 400 and/or may be provided as a separate user manipulatable element of the card. In this way, when the user presses the switch to active his or her card (or otherwise manipulates a manipulatable element of the card), the EAP material within the switch (or other manipulatable element) generates charge that can be stored as power within the power storage component and/or can be used directly by the power electronics to activate the tactile sensation generator. An exemplary embodiment in which the EAP power generator is incorporated within an input manipulandum (e.g., a switch 100 or 400 as described above with respect to the first or second exemplary RFID cards 101 or 401, respectively) will now be discussed with reference to FIGS. 2, 3, 5, and 6.

When the user properly engages an input manipulandum of an RFID card (e.g., by pressing a switch 100 or 400 of the first or second exemplary RFID card 101 or 401, respectively), support cushions within either of the first or second exemplary RFID cards 101 or 401 transition from an uncompressed state (see FIG. 2 or 5) to a compressed state (see FIG. 3 or 6). Because the support cushions are formed of EAP material, the support cushions generate an electric charge upon being compressed. The generated charge may be used (either immediately by output to the power electronics or after being stored in the power storage component) to drive a tactile sensation actuator. In one embodiment, the same device formed of the EAP material may be used both as a generator of power and as a tactile sensation generator.

In another embodiment, the power generator and/or the tactile sensation generator may include a device formed of a piezoelectric material. A piezoelectric power generator may be incorporated within the switch 400 and/or may be provided as a separate user manipulatable element of the card. In this way, when the user presses the switch to active his or her card (or otherwise manipulates a manipulatable element of the card), the piezoelectric material within the switch (or other manipulatable element) generates charge that can be stored as power within the power storage component and/or can be used directly by the power electronics to activate the tactile sensation generator. An exemplary embodiment in which the piezoelectric power generator is incorporated within an input manipulandum (e.g., a switch 100 or 400 as described above with respect to the first or second exemplary RFID cards 101 or 401, respectively) will now be discussed with reference to FIGS. 2, 3, 5, and 6.

When the user properly engages an input manipulandum of an RFID card (e.g., by pressing a switch 100 or 400 of the first or second exemplary RFID card 101 or 401, respectively), support cushions within either of the first or second exemplary RFID cards 101 or 401 transition from an uncompressed state (see FIG. 2 or 5) to a compressed state (see FIG. 3 or 6). Because the support cushions are formed of piezoelectric material, the support cushions generate an electric charge upon being compressed. The generated charge may be used (either immediately by output to the power electronics or after being stored in the power storage component) to drive a tactile sensation actuator. In one embodiment, the same device formed of the piezoelectric material may be used both as a generator of power and as a tactile sensation generator.

In another embodiment, the power generator may, for example, include a device such as a solar cell. In yet another embodiment, the power generator may be provided as a kinetic power generator that is adapted to generate electricity upon experiencing accelerations imparted to the card as it is carried and moved by a user. Accordingly, kinetic power generators include an inertial mass that is configured to be accelerated by the daily motions imparted to the card. The inertial mass may be connected to an electromagnetic, electro-active polymer, or piezoelectric power generation element. An example of technology suitable for converting inertial motion of an inertial mass to electrical energy is disclosed in U.S. Pat. Nos. 4,091,302 and 6,858,970, both of which are hereby incorporated by reference for all purposes as if fully set forth herein. An example of technology suitable for converting inertial motion of an inertial mass to electrical energy using an electromagnetic generator is disclosed in U.S. Pat. No. 6,244,742, which is hereby incorporated by reference for all purposes as if fully set forth herein. An example of technology suitable for converting inertial motion of an inertial mass to electrical energy using electro-active polymer material is disclosed in U.S. Pat. No. 6,768,246, which is hereby incorporated by reference for all purposes as if fully set forth herein.

In one embodiment, a kinetic power generator may also be used as a tactile sensation generator. In such an embodiment, the same inertial mass is used both as part of a power generator and as part of a tactile sensation generator. Such a kinetic tactile sensation generator may include an inertial mass that is driven by an actuator (e.g., an electromagnetic actuator, EAP actuator, a piezoelectric actuator, etc.). When a current is applied to the actuator, the inertial mass is driven and the tactile sensations are imparted to the user. When, however, the actuator is not energized and the card is carried about by the user (e.g., in his or her pocket), the user imparts accelerations upon the card and the inertial mass is jarred about to apply forces to the power generation element (e.g., the electromagnetic, EAP, or piezoelectric power generation element). As a result of the imparted forces, power is generated. In this way, the inertial mass is used as part of a kinetic power generator when feedback is not being provided.

In one embodiment, the power generator may include a thermoelectric generator incorporated within a portion of the card. For example, one or more thermoelectric elements may be mounted within or upon the surface of the RFID card (e.g., first or second exemplary RFID card 101 or 401) such that a portion of the thermoelectric elements can be engaged by the fingers and/or palm of a user who is holding the card. Each thermoelectric element is a power generating element comprising a plurality of thermocouples for converting thermal energy into electric energy. Generally, the thermoelectric elements are arranged such that when a user engages one face of the card, the other face is exposed to the ambient air. In one embodiment, a pad location is provided upon the card to indicate to the user where the card is to be contacted by the user. Accordingly, the pad location includes an exposed face of the thermoelectric element. When a user holds a portion of the card at the pad location between his or her fingers, or against his or her palm, or between a finger and thumb, a heat differential is created between the user's fingers (or palm) as compared to the ambient air temperature. The created heat differential is used to generate electrical power that can be stored as power within the power storage component and/or can be used directly by the power electronics to activate the tactile sensation generator. An example of technology suitable for converting heat into electricity using a thermoelectric generator is disclosed in U.S. Pat. No. 6,304,520, which is hereby incorporated by reference for all purposes as if fully set forth herein.

In one embodiment of the present invention, the mechanical complexity of the switch shown in FIGS. 1-6 can be substantially reduced by providing a card 702 such as an RFID card as exemplarily described above with respect to FIGS. 1-6 that can be activated by flexing the card itself (e.g., as exemplarily shown, in FIGS. 7A and 7B) instead of pressing a switch such as the switches described above with respect to FIGS. 1-6. As used herein, the phrase “flexing the card” means that the card itself is flexed by the user from its ordinarily flat configuration to an arched configuration, wherein the arched configuration is characterized as defining an arc along, for example, the long axis of the card.

Referring to FIG. 7A, an un-flexed card 702 is held by a user in a manner such that slight squeezing of the user's fingers will cause the card to flex. Referring to FIG. 7B, the card 702 is flexed by the user wherein the flexed card is no longer being flat. Rather, the card is flexed to have an arched profile oriented along the long axis of the card 702. The card 702 shown in FIGS. 7A and 7B includes a flex-indicating electric signal generating means 704 affixed thereto, embedded therein, and/or otherwise comprising a portion thereof. The flex-indicating electric signal generating means 704 includes a material that produces an electrical signal when the card is flexed by the user (e.g., a material such as EAP material, piezoelectric material, and the like, or combinations thereof). In one embodiment, flex-indicating electric signal generating means 704 may be disposed upon an outer surface of the card 702, embedded within a center of the card 702, or comprise a portion of the card itself. Accordingly, when the card 702 is flexed, the flex-indicating electric signal generating means 704 is stressed, resulting in the generation of a flex-indicating electric signal. This flex-indicating electric signal may be used to connect an antenna incorporated within the card 702 (e.g., as exemplarily described above with respect to FIGS. 1-6) with an RFID IC also incorporated within the card 702 (e.g., as exemplarily described above with respect to FIGS. 1-6) for a period of time. Accordingly, the flex-indicating electric signal generating means 704 serves the substantially the same function as the switches 100 and 400 described previously with respect to FIGS. 1-6 by enabling the card to be activated (or otherwise accessed) by a reader and/or enabling the card to exchange data with the reader. The flex-indicating electric signal may also be used to enable the RFID IC (e.g., as exemplarily described above with respect to FIGS. 1-6) aboard the card 702 to be activated (or otherwise accessed) and/or to exchange data with a card reader, for example by being detected by on-board processing electronics that responds accordingly when the flex-indicating electric signal is detected.

In one embodiment, the flex-indicating electric signal generating means 704 serves both as a sensor for generating the signal when the card is flexed and as a tactile sensation generator for selectively producing a tactile sensation under electronic control using the methods and apparatus described above. In this way, one or more flex-indicating electric signal generating means 704 can serve as both a sensor for detecting user intent by producing a signal responsive to a user flexing the card and can serve as a feedback actuator indicating to the user through tactile stimulation the status of the card with respect to the RF interaction with a reader.

In one embodiment, one or more flex-indicating electric signal generating means 704 can serve also as a power generator, generating power when the card 702 is flexed by the user. Thus a card that is configured as described above with respect to FIGS. 7A and 7B is such that when the card is flexed, the elements composed of such materials will generate an electric signal, the electric signal being used either to power some or all of the card electronics and/or the electric signal being used to store power within a power storage component upon the card. In this way, a user can power his or her card by flexing the card itself and/or a user can store power in a power storage component within the card by flexing the card itself. In some embodiments, the user may flex the card repeatedly a number of times to charge the card to a desired level.

While the invention herein disclosed has been described by means of specific embodiments, examples and applications thereof, numerous modifications and variations could be made thereto by those skilled in the art without departing from the scope of the invention set forth in the claims.

What is claimed is:

1. A radio operated data card, comprising:
a housing adapted to be contacted by a user, the housing comprising first and second panels forming an outer surface of the housing;
an antenna coupled to the housing;
electronic circuitry coupled to the antenna, the electronic circuitry including a data memory and a transceiver for transferring data between the memory and a card reader via the antenna;
control electronics adapted to generate a control signal when at least one predetermined event has occurred between the electronic circuitry and the card reader; and
a tactile sensation generator coupled to the housing and connected to the electronic circuitry, the tactile sensation generator configured to generate a tactile sensation corresponding to the control signal, the tactile sensation adapted to be felt by a user via the housing to thereby inform the user of the occurrence of the at least one predetermined event, wherein
the antenna, the electronic circuitry, and the control electronics are sandwiched between the first and second panels.

2. The radio operated data card of claim 1, wherein the control electronics is adapted to generate a control signal having a unique profile corresponding to one of a plurality of predetermined events.

3. The radio operated data card of claim 1, wherein the control electronics is adapted to generate a control signal having a profile corresponding to a plurality of predetermined events.

4. The radio operated data card of claim 1, further comprising an input manipulandum coupled to the electronic circuitry, the input manipulandum adapted to be engaged by the user via the housing to connect the antenna to the electronic circuitry.

5. The radio operated data card of claim 4, wherein the input manipulandum includes at least one of a pressure-responsive switch, an accelerometer, a tilt sensor, and a temperature sensor.

6. The radio operated data card of claim 4, wherein the tactile sensation generator is integrated within the input manipulandum.

7. The radio operated data card of claim 4, wherein the tactile sensation generator is separate from the input manipulandum.

8. The radio operated data card of claim 1, wherein the tactile sensation generator is adapted to generate a localized tactile sensation directed at a predetermined area of the housing.

9. The radio operated data card of claim 1, wherein the tactile sensation generator is adapted to generate a generalized tactile sensation transferred throughout the housing.

10. The radio operated data card of claim 1, wherein the tactile stimulation generated includes a vibration sensation.

11. The radio operated data card of claim 10, wherein the tactile sensation generator includes an electro-active polymer material.

12. The radio operated data card of claim 10, wherein the tactile sensation generator includes a piezoelectric material.

13. The radio operated data card of claim 10, wherein the tactile sensation generator includes an electromagnetic actuator.

14. The radio operated data card of claim 1, wherein the tactile sensation generator includes an electric stimulus actuator.

15. The radio operated data card of claim 1, wherein the tactile sensation generator is further adapted to generate power.

16. The radio operated data card of claim 1, further comprising a power generator coupled to the housing, the power generator including at least one of a kinetic motion generator, a solar cell generator, and a thermoelectric generator.

17. The radio operated data card of claim 16, wherein the power generator includes at least one of an electro-active polymer material and a piezoelectric material.

18. The radio operated data card of claim 1, further comprising a means for storing electricity coupled to electronic circuitry.

19. A non-contact storage device, comprising:
a housing adapted to be contacted by a user;
an antenna coupled to the housing;
electronic circuitry coupled to the antenna, the electronic circuitry including a data memory and a transceiver for transferring data between the memory and a remote unit via the antenna;
control electronics adapted to generate a control signal corresponding to the status of a transfer of data between the data memory and the remote unit; and
a tactile sensation generator coupled to the housing and connected to the electronic circuitry, the tactile sensation generator configured to generate a tactile sensation corresponding to the control signal, the tactile sensation adapted to be felt by a user via the housing to thereby inform the user as to the status of the transfer of data.

20. The non-contact storage device of claim 19, wherein the control electronics is adapted to generate a control signal corresponding to a successful transfer of data between the card and the remote unit.

21. The non-contact storage device of claim 19, wherein the control electronics is adapted to generate a control signal corresponding to an unsuccessful transfer of data between the card and the remote unit.

22. The non-contact storage device of claim 19, wherein the control electronics is adapted to generate a control signal corresponding to the process of transferring data between the card and the remote unit.

23. A non-contact storage device, comprising:
a housing adapted to be contacted by a user;
an antenna coupled to the housing;
electronic circuitry coupled to the antenna, the electronic circuitry including a data memory and a transceiver for transferring data between the memory and a remote unit via the antenna;
control electronics adapted to generate a control signal corresponding to an authentication status of the card with respect to the remote unit; and
a tactile sensation generator coupled to the housing and connected to the electronic circuitry, the tactile sensation generator configured to generate a tactile sensation corresponding to the control signal, the tactile sensation adapted to be felt by a user via the housing to thereby inform the user as to the authentication status of the card with respect to the remote unit.

24. The non-contact storage device of claim 23, wherein the control electronics is adapted to generate a control signal corresponding to a successful authentication of the card with respect to the remote unit.

25. The non-contact storage device of claim 23, wherein the control electronics is adapted to generate a control signal corresponding to an unsuccessful authentication of the card with respect to the remote unit.

26. A non-contact storage device, comprising:
a housing adapted to be contacted by a user;
an antenna coupled to the housing;
electronic circuitry coupled to the antenna, the electronic circuitry including a data memory and a transceiver for transferring data between the memory and a remote unit via the antenna;
control electronics adapted to generate a control signal corresponding to the status of a payment transaction between the card and the remote unit; and
a tactile sensation generator coupled to the housing and connected to the electronic circuitry, the tactile sensation generator configured to generate a tactile sensation corresponding to the control signal, the tactile sensation adapted to be felt by a user via the housing to thereby inform the user as to the status of the payment transaction.

27. The non-contact storage device of claim 26, wherein the control electronics is adapted to generate a control signal corresponding to a successful payment transaction between the card and the remote unit.

28. The non-contact storage device of claim 26, wherein the control electronics is adapted to generate a control signal corresponding to an unsuccessful payment transaction between the card and the remote unit.

29. A non-contact storage device, comprising:
a housing adapted to be contacted by a user;
an antenna coupled to the housing;
electronic circuitry coupled to the antenna, the electronic circuitry including a data memory and a transceiver for transferring data between the memory and a remote unit via the antenna;
control electronics adapted to generate a control signal when the electronic circuitry has been activated in the presence of a radio signal transmitted by the remote unit; and
a tactile sensation generator coupled to the housing and connected to the electronic circuitry, the tactile sensation generator configured to generate a tactile sensation corresponding to the control signal, the tactile sensation adapted to be felt by a user via the housing to thereby inform the user that the electronic circuitry has been activated by the remote unit.

30. A non-contact storage device, comprising:
a housing adapted to be contacted by a user;
an antenna coupled to the housing;
electronic circuitry coupled to the antenna, the electronic circuitry including a data memory and a transceiver for transferring data between the memory and a remote unit via the antenna;
an input manipulandum coupled to the electronic circuitry, the input manipulandum adapted to be engaged by the user to connect the antenna to the electronic circuitry;
control electronics adapted to generate a control signal when the electronic circuitry has not been activated within a predetermined amount of time after the user engages the input manipulandum; and
a tactile sensation generator coupled to the housing and connected to the electronic circuitry, the tactile sensation generator configured to generate a tactile sensation corresponding to the control signal, the tactile sensation adapted to be felt by a user via the housing to thereby inform the user that the electronic circuitry has not been activated.
